(19) United States
(12) Patent Application Publication
(10) Pub. No.: US 2026/0168599 A1
(43) Pub. Date: Jun. 18, 2026

(54) EXTREME COOLANT HOSE ASSEMBLY WITH HEATER SYSTEM FOR COVER HEATING

(71) Applicant: PARKER-HANNIFIN CORPORATION, Cleveland, OH (US)

(72) Inventors: Steven M. POWELL, Chardon, OH (US); Lee D. BEITZEL, Ravenna, OH (US)

(73) Assignee: PARKER-HANNIFIN CORPORATION, Cleveland, OH (US)

(21) Appl. No.: 19/126,791

(22) PCT Filed: Jan. 25, 2024
(86) PCT No.: PCT/US2024/012854

§ 371 Date: May 2, 2025

Related U.S. Application Data
(60) Provisional application No. 63/443,567, filed on Feb. 6, 2023.
(60) Provisional application No. 63/494,593, filed on Apr. 6, 2023.

(51) Int. Cl. F16L 11/12; F16L 11/08; F16L 53/38; F16L 59/153

(52) U.S. Cl. CPC F16L 11/12; F16L 11/085; F16L 53/38; F16L 59/153

(57) ABSTRACT

A hose assembly comprising: an inner hose core (12), an insulating layer (16) that is positioned radially externally relative to the inner hose core; an electrical resistance element (20) that is positioned radially externally relative to the insulating layer; and a cover layer (24) that is positioned radially externally relative to the insulating layer.

### FIELD OF INVENTION

The present application relates broadly to heated hoses, and more particularly to a heated hose construction for operating in extreme coolant applications in a manner that prevents condensation on an outer hose cover.

### BACKGROUND

Conventional electrical heated hoses are fabricated by wrapping an electrical conductor around an inner hose tube, and then enshrouding the wrapped inner hose tube in a sheathing or outer hose cover. In many applications that employ heated hoses, the inner hose tube is reinforced with a fiber or aramid braid, and the inner hose tube with the reinforcement braid is covered with a polyurethane sleeve or hose cover. For heating, before enshrouding within the hose cover the inner hose tube is wrapped with conductive wiring positioned between the reinforcement layer and the outer hose cover, and the conductive wiring typically includes a flat copper wire that can either be a solid ribbon or braided strands. The conductive wiring functions as a resistance heating element, whereby heat is generated by an electric current flowing through the conductive wiring when the conductive wiring is electrically connected to an input power source. In typical cold-temperature environmental operating conditions of common heated hose applications, the principal issue lies in preventing freezing of the operating fluid that flows through the inner hose tube due to a cold external environment. In such applications, thermal conduction travels from the conductive wiring inward to the inner hose tube to aid in preventing freezing of the operating fluid under relatively cold environmental or external conditions.

In contrast, the current disclosure applies to applications of hose assemblies that employ extreme coolant that flows through the inner hose tube and having a temperature colder than at least −50° C. In one principal application, for example, semiconductor chip production utilizes extreme heat to maintain proper flow of process gases. Chillers are utilized to help regulate the environment necessary for production processes using coolant pumped through hose assemblies. The coolants that are utilized in such conventional semiconductor chip production systems are at extreme cold temperatures as low as −50° C. to −60° C., but as semiconductor chip production advances, even colder coolant temperatures below −70° C. to about −90° C. may be employed. For applications that employ extreme coolant operating at such substantially negative temperatures, there is no need to be concerned about heating the operating fluid as may arise under more ordinary environmental conditions. For extreme coolant applications, therefore, conductive heater wiring has not been employed because a conventional heated hose has not been considered beneficial in such applications.

To operate at such substantially negative temperatures, in conventional extreme coolant hose assemblies the inner hose tube typically is surrounded by an appropriate insulating layer, such as for example an aerogel impregnated insulation material. The insulating layer helps maintain the coolant at the desired extreme cold temperature. An issue has arisen, however, with respect to newer semiconductor chip production systems that are operating at coolant temperatures that reach about −70° C. or below. At such lower coolant temperatures, with the use of conventional hose assemblies an aerogel impregnated insulation is insufficient to prevent significant cooling of the outer hose cover of the hose assembly. As a result, the external temperature at the hose cover surface may cool to be below the ambient dew point temperature of the surrounding environment, which causes condensation as water or frost to form on the external surface of the hose cover. Condensation in turn can result in water leaking from the hose cover onto the floor or other equipment in proximity to the hose assembly, which can create hazards to workers and can damage electronic equipment.

Condensation also can occur when two or more conventional cold hose assemblies are bundled together, which is common in semiconductor chip production systems. Bundled hose assemblies at extremely cold temperatures cause each other's surfaces to become colder than if each individual hose assembly in the bundle were isolated and exposed only to ambient conditions.

### SUMMARY OF INVENTION

Accordingly, there is a need in the art for an extreme cold temperature hose assembly with capability to provide a coolant flow with the coolant having a temperature below about −70° C. without the formation of condensation as experienced by conventional cold temperature hose assemblies. In an exemplary embodiment, a hose assembly is configured as a multi-layer structure that includes an inner hose core, and further may include a reinforcing layer positioned radially externally or wrapped around the inner hose core. The hose assembly further includes an insulating layer that is positioned or wrapped radially externally relative to the inner hose core to provide insulation to aid in keeping system coolant flowing inside the inner hose core at a desired temperature level, which is particularly important when maintaining extreme cold coolant fluid temperatures. The hose assembly further includes an electrical resistance element that is positioned or wrapped radially externally relative to the insulating layer. The hose assembly further includes a cover layer that also is positioned radially externally relative to the insulating later. The electrical resistance element may be positioned either between the insulating layer and the cover layer, or positioned radially externally relative to the cover layer.

The electrical resistance element provides a low level of heating to the cover layer that prevents the formation of condensation in the form of water or frost on a radially external surface of the cover layer. For example, the electrical resistance element may provide a low level of heat to the cover layer sufficient to raise the temperature of the external surface of the cover layer by about 5° C. to 17° C., which in typical extreme coolant applications is appropriate to ensure that the cover layer's radially external surface temperature is above the ambient dew point temperature. The electrical resistance element may be configured as wound helical wiring or braided wiring. Because the electrical resistance element provides a relatively low level of heating, and because the resistance element is positioned or wrapped radially externally relative to the insulating layer, heat generated by the electrical resistance element is blocked by the insulating layer from conduction to the inner hose core, which otherwise potentially could result in undesirable heating of the inner hose core. In this manner, in contrast to conventional heated hose assemblies that operate to heat the inner hose core and the operating fluid, in the heated hose assembly of the current disclosure the outer hose cover is heated while heat is precluded from ingress to the inner hose core and coolant. In addition, the heat provided to the cover layer by the electrical resistance element also allows for multiple hose assemblies to be bundled together without resulting in condensation.

An aspect of the invention, therefore, is a hose assembly having a heater configuration for heating a hose cover layer to prevent condensation on a radially external surface of the hose cover layer. In exemplary embodiments, the hose assembly includes: an inner hose core; an insulating layer that is positioned radially externally relative to the inner hose core; an electrical resistance element that is positioned radially externally relative to the insulating layer; and a cover layer that is positioned radially externally relative to the insulating layer.

In another exemplary embodiment, the hose assembly further may include a thermal barrier layer positioned radially between the insulating layer and the electrical resistance element. The thermal barrier layer is made of a thermally reflective material that operates to reflect heat to direct radiant heat from the electrical resistance element toward the cover layer while preventing heat ingress into the insulating layer, which otherwise potentially could result in undesirable heating of the inner hose core. The result is improved efficiency of heating the cover layer because essentially all the heat generated by the electrical resistance element is directed for heating the cover layer.

In another exemplary embodiment, the hose assembly further may include a second thermal barrier layer positioned radially outward of the electrical resistance element and between the electrical resistance element and the cover layer.

In another exemplary embodiment, the hose assembly further may include a reinforcing layer positioned radially externally relative to the inner hose core to increase the pressure-containing capacity of the inner hose core.

In another exemplary embodiment, the hose assembly further may include an electromagnetic interference (EMI) shielding layer positioned radially externally relative to the electrical resistance element. The EMI shielding layer may be used in certain applications as warranted to shield the electrical resistance element from EMI sources to prevent interference with the operation of the electrical resistance element.

In another exemplary embodiment, the thermal barrier layer is spiral wrapped around the insulating layer.

In another exemplary embodiment, the thermal barrier layer includes one or more of an aluminum foil, a metallic coated film, or a metalized Mylar® film.

In another exemplary embodiment, the electrical resistance element is radially positioned between the insulating layer and the cover layer.

In another exemplary embodiment, the electrical resistance element is positioned radially externally relative to the cover layer.

In another exemplary embodiment, the electrical resistance element is configured to provide a level of heat to the cover layer sufficient to raise a temperature of a radially external surface of the cover layer by 5° C. to 17° C.

In another exemplary embodiment, the electrical resistance element is configured to provide a level of heat to the cover layer sufficient to raise a temperature of a radially external surface of the cover layer by an amount sufficient to be above an ambient dew point temperature.

In another exemplary embodiment, the electrical resistance element is configured as wound helical wiring spiral-wrapped radially externally relative to the insulating layer.

In another exemplary embodiment, the wound helical wiring includes at least one pair of electrical wires oriented as 180° opposing spirals.

In another exemplary embodiment, the electrical resistance element is configured as braided wiring wrapped radially externally relative to the insulating layer.

In another exemplary embodiment, the electrical resistance element has a nominal resistance of 0.6-15 ohms per meter corresponding to a desired output power of 15-75 watts for operation in a constant voltage low amperage input power system.

In another exemplary embodiment, the electrical resistance element has a nominal resistance of approximately 0.3-1.0 ohms per meter corresponding to a desired output power of 15-75 watts for operation in a constant amperage low voltage input power system.

In another exemplary embodiment, the reinforcing layer is wrapped around the inner hose core radially internally relative to the insulating layer.

In another exemplary embodiment, the reinforcing layer includes one or more of a stainless steel braid material or an aramid fiber.

In another exemplary embodiment, the EMI shielding layer is configured as a foil layer that is wrapped radially externally relative to the electrical resistance element.

In another exemplary embodiment, the EMI shielding layer is applied radially externally relative to the electrical resistance element and radially internally relative to the cover layer.

In another exemplary embodiment, the inner hose core is a tube that includes one or more of polytetrafluoroethylene (PTFE), a corrugated metal, or a linear low density polyethylene (LLDPE).

In another exemplary embodiment, the insulating layer includes a PTFE-based or silica-based aerogel insulation material that is infused into a base matrix including one or more of fiberglass, felt, or a fiber matrix.

In another exemplary embodiment, the insulating layer includes a strip of insulating material that is spiral wrapped radially externally relative to the inner core tube.

In another exemplary embodiment, a spiral wrapped configuration of the insulating layer is applied with a 50% overlap to provide a uniform double layer of insulating material along a longitudinal length of the inner hose core.

In another exemplary embodiment, the cover layer is an elastomer including one or more of silicone, a thermoplastic polyurethane, or a thermoplastic vulcanizate (TPV) with flexural modulus less than 30,000 psi with elongation at break greater than 300%.

In another exemplary embodiment, the hose assembly further may include a first shroud that encompasses a first end of the hose assembly; wherein the electrical resistance element includes lead wires that are electrically connected to wiring of the electrical resistance element, the lead wires extending through passages formed through an outer wall of the first shroud for connection to an external input power source; and a set of first spliced connections that is located internally within the first shroud and that electrically connects the lead wires to the wiring of the electrical resistance element.

In another exemplary embodiment, the hose assembly further may include a second shroud that encompasses a second end of the hose assembly opposite from the first end; and a second spliced connection that is located internally within the second shroud and that electrically connects opposing elements of the wiring of the electrical resistance element to each other.

In another exemplary embodiment, the first shroud is configured as a first clam shell that attaches the hose assembly to a first hose fitting for communicating fluid to or from the hose assembly.

In another exemplary embodiment, the second shroud is configured as a second clam shell that attaches the hose assembly to a second hose fitting for communicating fluid to or from the hose assembly

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a drawing depicting an elevational longitudinal view, partially cut away, of an exemplary heated hose assembly showing the different layers of the hose assembly in accordance with a first embodiment of this disclosure.

FIG. 2 is a drawing depicting an elevational longitudinal view, partially cut away, of an exemplary heated hose assembly showing the different layers of the hose assembly in accordance with a second embodiment of this disclosure.

FIG. 2A is a drawing depicting an elevational longitudinal view, partially cut away, of an exemplary heated hose assembly showing the different layers of the hose assembly in accordance with a variation of the second embodiment of this disclosure.

FIG. 3 is a drawing depicting an elevational longitudinal view, partially cut away, of an exemplary heated hose assembly showing the different layers of the hose assembly in accordance with a third embodiment of this disclosure.

FIG. 4 is a drawing depicting an elevational longitudinal view, partially cut away, of an exemplary heated hose assembly showing the different layers of the hose assembly in accordance with a fourth embodiment of this disclosure.

FIG. 5 is a drawing depicting an elevational longitudinal view, partially cut away, of an exemplary heated hose assembly showing the different layers of the hose assembly in accordance with a fifth embodiment of this disclosure.

FIG. 6 is a drawing depicting an elevational longitudinal view, partially cut away, of an exemplary heated hose assembly showing the different layers of the hose assembly in accordance with a sixth embodiment of this disclosure.

FIG. 7 is a schematic drawing depicting a first configuration of splicing for electrically connecting the electrical resistance element to external power leads.

FIG. 8 is a schematic drawing depicting a second configuration of splicing the electrical resistance element on an opposite end of the hose assembly relative to the first splicing configuration of FIG. 7, for internal splicing of opposing elements of the electrical resistance element.

### DETAILED DESCRIPTION

Embodiments of the present disclosure will now be described with reference to the drawings, wherein like reference numerals are used to refer to like elements throughout. It will be understood that the figures are not necessarily to scale.

Embodiments of the present disclosure provide an enhanced configuration of an extreme cold temperature hose assembly with capability to provide a coolant flow with the coolant having a temperature below about −70° C., down to −90° C. or below, and without the formation of condensation as experienced by conventional cold temperature hose assemblies. To prevent condensation, the hose assembly includes an electrical resistance element that is positioned or wrapped radially externally relative to an insulating layer, such that the electrical resistance element operates to heat an outer cover layer of the hose assembly without heating the inner hose core. By heating the cover layer of the hose assembly, a radially external surface of the cover layer is maintained at a temperature above an ambient dew point temperature, thereby preventing condensation from forming on such external surface of the cover layer. Embodiments of the hose assembly, therefore, particularly are suitable for use in advanced semiconductor chip production systems, or in other applications that may utilize a comparable extreme cold temperature coolant flow.

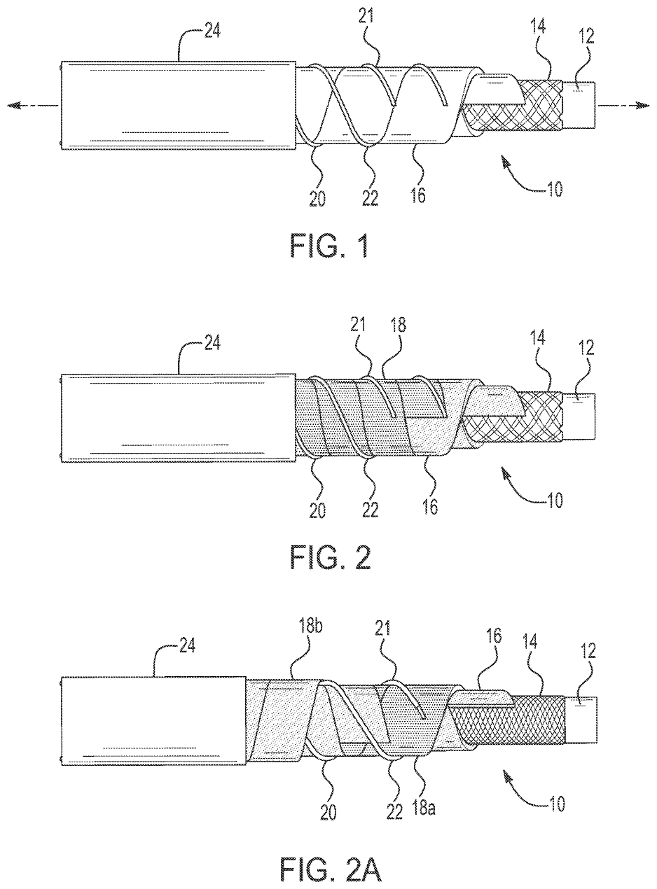

FIG. 1 is a drawing depicting an elevational longitudinal view, partially cut away, of an exemplary heated hose assembly 10 showing the different layers of the hose assembly in accordance with a first embodiment of this disclosure. As used in this disclosure, the terms “internal” and “external” generally refer to relative radial positions from a center longitudinal axis (indicated by the double arrow line) of the hose assembly 10. In the embodiment depicted in FIG. 1, the hose assembly 10 is configured as a multi-layer structure that includes an inner hose core 12, and further may include a reinforcing layer 14 wrapped around or otherwise positioned radially externally relative to the inner hose core 12. The inner hose core 12 is the innermost component of the hose assembly that carries the system operating fluid, such as for example an extreme coolant material. The reinforcing layer 14 optionally may be employed for reinforcing the inner hose core 12 to increase the pressure-containing capacity of the inner hose core as may be experienced in certain applications.

The hose assembly 10 further includes an insulating layer 16 that is positioned or wrapped radially externally relative to the inner hose core 12 to provide insulation to aid in keeping system coolant flowing inside the inner hose core at a desired cold temperature level, which is particularly important when maintaining extreme cold coolant fluid temperatures. The hose assembly 10 further includes an electrical resistance element 20 that is positioned or wrapped radially externally relative to the insulating layer 16. The hose assembly further includes a cover layer 24 that also is positioned radially externally relative to the insulating later 16. The cover layer 24 protects the reinforcing layer 14 and the inner hose core 12 from environmental conditions and wear. In the example configuration of FIG. 1, the electrical resistance element 20 is positioned radially between the insulating layer 16 and the cover layer 24.

The electrical resistance element 20 provides a low level of heating to the cover layer 24 that prevents the formation of condensation in the form of water or frost on a radially external surface of the cover layer 24. For example, the electrical resistance element may provide a low level of heat to the cover layer sufficient to raise the temperature of the radially external surface of the cover layer 24 by about 5° C. to 17° C., which in typical extreme coolant applications is appropriate to ensure that the cover layer's external surface temperature is above the ambient dew point temperature. Because the radially external surface temperature of cover layer 24 is maintained above the ambient dew point temperature, condensation does not form on such external surface of the cover layer. Because the electrical resistance element 20 provides a relatively low level of heating, and because the resistance element 20 is positioned or wrapped radially externally relative to the insulating layer 16, heat generated by the electrical resistance element 20 is blocked by the insulating layer 16 from conduction to the inner core tube 12, which otherwise potentially could result in undesirable heating of the inner hose core and the coolant. In this manner, in contrast to conventional heated hose assemblies that operate to heat the inner hose core and operating fluid, in the heated hose assembly of the current disclosure the outer hose cover is heated while heat is precluded from ingress to the inner hose core and coolant. In addition, the heat provided to the cover layer 24 by the electrical resistance element 20 also allows for multiple hose assemblies to be bundled together without resulting in condensation.

The inner hose core 12 may be a polytetrafluoroethylene (PTFE) tube having a minimum operating temperature of −70° C. or below, and preferably going down to at least −90° C. or below. The precise material that is employed may be selected as warranted for any particular application and associated temperature range. Other materials that may be used for the inner hose core 12 for use in extreme cold coolant applications, include, but are not limited to, one or more of a corrugated metal (e.g., stainless steel) core tube, linear low density polyethylene (LLDPE), or other low temperature capable materials. The reinforcing layer 14 may be a stainless steel braid material, although other suitable reinforcing materials may be employed as suitable for any particular application including aramid fibers and the like.

The insulating layer 16 may be a silica-based aerogel insulation material which is typically infused into some base matrix such as, for example PTFE, fiberglass, or otherwise infused into a mechanically sound fabric, felt or fiber matrix, or a polyester/polyethylene fiber matting matrix, as are known in the art. As shown in the example depicted in FIG. 1, a strip of the insulating material 16 is spiral wrapped onto a radially exterior surface of the inner components of the hose assembly including the combination of the inner core 12 and the option reinforcing layer 14 when present. The spiral wrapped configuration may be applied with a 50% overlap to provide a substantially uniform double layer of insulating material along a longitudinal length of the inner hose core 12. Other materials may be used for the insulating layer 16 as may be appropriate for a particular application, such as for example a fiberglass insulation material.

In the example of FIG. 1, the electrical resistance element 20 is configured as wound helical wiring that is positioned radially between the insulating layer 16 and the cover layer 24. The electrical resistance element 20 may be at least one pair of copper, aluminum, electrically conductive carbon fiber, specialty resistance alloy, or other electrical wires 21, 22 oriented as 180° opposing spirals, each of which may be plastic-coated and spiral-wound around the insulating layer 16. In an exemplary embodiment, the electrical resistance element 20 is uniformly applied to the hose assembly 10.

Two different types of input power systems principally are known in the art for use with heated hose systems, including constant voltage systems and constant amperage systems. In a constant voltage system, which are more common, the voltage input is constant, and the electrical resistance element is configured at the time of manufacture to have a predetermined nominal resistance per length to achieve the desired output power as matched to the constant voltage input. In a constant amperage system, the voltage input is variable and therefore the output power is not fixed based on the manufactured nominal resistance per length of the electrical heating element, insofar as the voltage level is adjustable based on the resistance of the resistance heating element per length to achieve the constant amperage corresponding to the desired total output power.

Accordingly, potential input power systems for the hose assembly 10 include constant amperage with varying voltage and constant voltage with varying amperage. As a suitable example for the operation in a constant amperage low voltage system, the electrical resistance element may have a manufactured nominal resistance of approximately 0.3-1.0 ohms per meter. For example, if the nominal resistance of the electrical resistance element is manufactured to be 0.6 ohms per meter for use in a 5-amp constant amperage system, a suitable output power of 15-75 watts may be achieved through adjusting the input voltage level. As a suitable example for the operation in a constant voltage low amperage system, the electrical resistance element may have a manufactured nominal resistance of approximately 0.6-15 ohms per meter as matched for a given constant input voltage, corresponding to a comparable desired output power of 15-75 watts dependent on the voltage level of the constant voltage power source. The chart below illustrates example parameters of the properties of the electrical resistance element, as matched with the electrical operating parameters (voltage and amperage), and the resultant calculations for the total output power in the range of 15-75 watts. It will be appreciated that the examples in the chart below are non-limiting, and the various parameters may be adapted as suitable for any particular application.

### Example 1: Constant 5 Amperage System with 15 Watts Per Meter Hose Heating

| | | | Hose | | |
|---|---|---|---|---|---|
| Hose | | Constant | Resistance | Total | Total |
| Length | Voltage | Current | per Meter | Resistance | Power |
| (mtr) | (Volts) | (amps) | (ohms/mtr) | (ohms) | (Watts) |
| 1.0 | 3.0 | 5.00 | 0.60 | 0.60 | 15.00 |
| 3.0 | 9.0 | 5.00 | 0.60 | 1.80 | 45.00 |
| 5.0 | 15.0 | 5.00 | 0.60 | 3.00 | 75.00 |

### Example 2: Constant 15 Voltage System with 15 Watts Per Meter Hose Heating

| | | | Hose | | |
|---|---|---|---|---|---|
| Hose | Constant | | Resistance | Total | Total |
| Length | Voltage | Current | per Meter | Resistance | Power |
| (mtr) | (Volts) | (amps) | (ohms/mtr) | (ohms) | (Watts) |
| 1.0 | 15.0 | 1.00 | 15.00 | 15.00 | 15.00 |
| 3.0 | 15.0 | 3.00 | 1.67 | 5.00 | 45.00 |
| 5.0 | 15.0 | 5.00 | 0.60 | 3.00 | 75.00 |

The cover layer 24 may be a low temperature capable elastomer including one or more of silicone, a thermoplastic polyurethane or a thermoplastic vulcanizate (TPV) with flexural modulus less than 30,000 psi with elongation at break greater than 300%. Other materials may be used for cover layer 24 as may be appropriate for a given application. As referenced above, the heat level provided by the electrical resistance element 20 is set at a level sufficient to adequately heat the cover layer 24 to prevent condensation, but typically is low enough for the insulating layer 16 to block the heat from ingress to the inner hose core 12. In certain circumstances, there may be a need to operate the electrical resistance element at a level at which it may be desirable to provide further heat protection for the inner hose core in addition to the typical insulating layer.

FIG. 2 is a drawing depicting an elevational longitudinal view, partially cut away, of an exemplary heated hose assembly showing the different layers of the hose assembly in accordance with a second embodiment of this disclosure, which provides additional heat protection for the inner hose core and enhanced heating of the outer cover layer to prevent condensation. The embodiment of FIG. 2 is a variation on the embodiment of FIG. 1, and therefore like components are identified with like reference numerals. In example of FIG. 2, the hose assembly 10 further may include a thermal barrier layer 18 positioned radially between the insulating layer 16 and the electrical resistance element 20 to provide further heat protection for the inner hose core 12.

The thermal barrier layer 18 is made of a thermally reflective material that operates to reflect and direct radiant heat from the electrical resistance element toward the cover layer while preventing heat ingress into the insulation layer, which otherwise potentially could result in undesirable heating of the inner hose core 12 and the coolant. The result is improved efficiency of heating the cover layer because essentially all the heat generated by the electrical resistance element is directed for heating the cover layer. In addition, the thermal barrier layer 18 operates to better distribute the heater wire energy of the electrical resistance element 20 across the entire inner surface of the cover 24 to prevent additional condensation that otherwise may occur between the electrical resistance element wiring and the hose surface. With the thermal barrier layer 18, therefore, heat is better distributed, and condensation does not develop at the cold operating temperature and energy conditions of the electrical resistance element. The thermal barrier layer 18 may be an aluminum foil spiral wrapped around or otherwise positioned radially externally relative to the insulating layer 16. Other materials may be used for the thermal barrier layer 18 as may be appropriate for a given application such as for example, but not limited to, one or more of a metallic coated film, or a metalized Mylar® or other impermeable film.

FIG. 2A is a drawing depicting an elevational longitudinal view, partially cut away, of an exemplary heated hose assembly showing the different layers of the hose assembly in accordance with a variation of the second embodiment of FIG. 2. In the variation of FIG. 2A, thermal barrier layers are positioned both radially inward and radially outward of the electrical resistance element. For example, FIG. 2A depicts a first thermal barrier layer 18a positioned radially inward of the electrical resistance element 20, and a second thermal barrier layer 18b positioned radially outward of the electrical resistance element 20 and between the electrical resistance element and the cover layer. Sandwiching the electrical resistance element between two thermal barrier layers enhances the effectiveness of the heat distribution of the heat generated by the electrical resistance element for a better heat distribution applied to the cover layer.

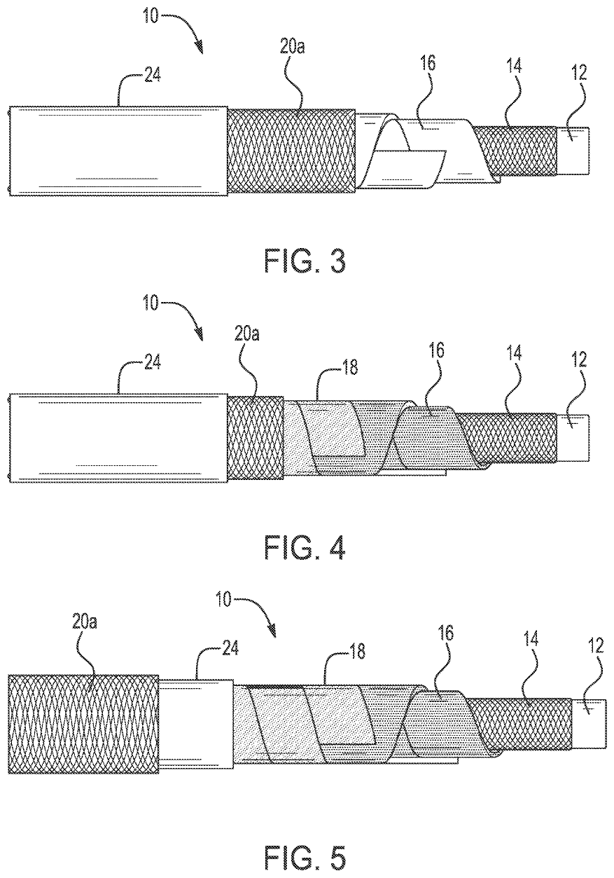

FIGS. 3-6 depict additional variations on the embodiments of FIGS. 1 and 2 for the heated hose assembly 10. For simplicity, not every potential combination of individual features is shown in the figures, but it will be appreciated that the various individual features may be mixed and matched in any combination of one or more of such variations as may be suitable for any particular application.

As one potential variation, the electrical resistance element may be configured as a braided wiring 20a instead of wound helical wires 20, as depicted for example in FIG. 3. The braided wiring 20a further is illustrated in FIG. 4 in use in combination with the thermal barrier layer 18. In the above examples, the electrical resistance element 20/20a is positioned specifically radially internally relative to the cover layer 24 while being positioned radially externally relative to the insulating layer 16. In another exemplary embodiment, the electrical resistance element may be positioned radially externally relative to or around the external surface of the cover layer 24. For example, FIG. 5 illustrates the use of an external braided electrical resistance element 20a positioned and wrapped radially externally relative to the cover layer 24. As referenced above, individual features may be mixed and matched as may be suitable for a given application. For example, in FIG. 5 the external braided electrical resistance element 20a is used in combination with the thermal barrier layer 18, whereas in another example the thermal barrier layer may be excluded. In addition, an electrical resistance element configured as wound wiring also may be applied radially externally around or relative to the radial external surface of the cover layer.

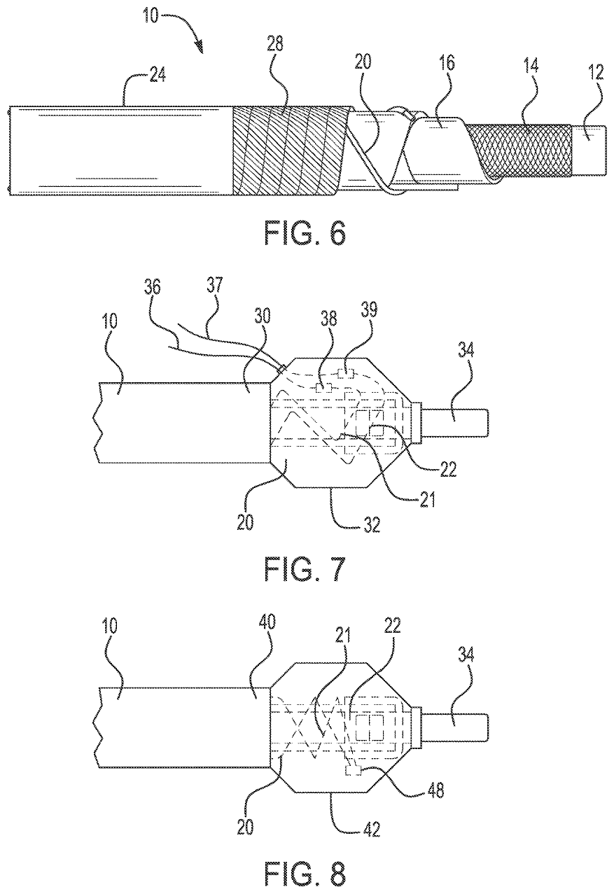

In another exemplary embodiment, the hose assembly further may include an electromagnetic interference (EMI) shielding layer positioned radially externally relative to the electrical resistance element. The EMI shielding layer may be used in certain applications as warranted to shield the electrical resistance element from EMI sources to prevent interference with the operation of the electrical resistance element, and also to prevent any EMI generated by the electrical resistance element from interfering with the operation of nearby processing equipment. The EMI shielding layer may be configured as a foil layer that is wrapped around or otherwise applied radially externally relative to the electrical resistance element. For example, FIG. 6 illustrates the use of an EMI shielding layer 28 applied radially externally relative to the electrical resistance element 20 and radially internally relative to the cover layer 24. As indicated in connection with other features, the EMI shielding layer may be used or mixed and matched with the other variations, such as for example with the braided configuration electrical resistance element 20a, or with or without the thermal barrier layer 18, or other combinations of features.

FIG. 7 is a schematic drawing depicting a first configuration of splicing the electrical resistance element 20 (or 20a) to external power leads. The hose assembly 10 further may include a first shroud 32 that encompasses a first end 30 of the hose assembly 10. The first shroud 32 may be configured as a clam shell element that attaches the hose assembly 10 to a first hose fitting 34 for communicating fluid to or from the hose assembly 10. The electrical resistance element 20 further includes electrical lead wires 36 and 37 that are electrically connected to an external or remote input power source (not shown), and the electrical lead wires 36 and 37 are threaded or otherwise extend through passages formed through an outer wall of the first shroud 32. The electrical leads wires 36 and 37 from the input power source are electrically connected respectively to helical wires 21 and 22 of the electrical resistance element 20 at a set of first spliced connections 38 and 39 that are located internally within the first shroud 32. It will be appreciated that although the splicing is shown in connection with the helical wire configuration of the electrical resistance element, a comparable splicing configuration may be employed in connection with the braided wire configuration of the electrical resistance element.

FIG. 8 is a schematic drawing depicting a second configuration of splicing the electrical resistance element 20 (or 20a) on an opposite end of the hose assembly relative to the first splicing configuration of FIG. 7, for internal splicing of opposing elements of the electrical resistance element. The second splicing configuration corresponds to an internal connection of the helical wires 21 and 22 of the electrical resistance element 20 to each other at a second end of the hose assembly opposite from the first end of the hose assembly where the power is supplied. As shown in FIG. 8, the hose assembly 10 includes a second shroud 42 that encompasses a second end 40 of the hose assembly 10. The second shroud 42 also may be configured as a clam shell element that attaches the hose assembly 10 to a second hose fitting 44 for communicating fluid to or from the hose assembly 10. At the second splicing configuration, the helical wires 21 and 22 of the electrical resistance element 20 are spliced to each other at a second spliced connection 48 that is located internally within the second shroud 42. As in the previous splicing configuration of FIG. 7, it will be appreciated as to the internal splicing of FIG. 8 that although the splicing in shown in connection with the helical wire configuration of the electrical resistance element, a comparable splicing configuration may be employed in connection with the braided wire configuration of the electrical resistance element.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above-described elements (components, assemblies, devices, compositions, etc.), the terms (including a reference to a “means”) used to described such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A hose assembly comprising:
an inner hose core,
a thermally insulating layer that is positioned radially externally relative to the inner hose core;
an electrical resistance element that is positioned radially externally relative to the thermally insulating layer; and
a cover layer that is positioned radially externally relative to the thermally insulating layer.

2. The hose assembly of claim 1, further comprising a thermal barrier layer radially positioned between the insulating layer and the electrical resistance element and that is made of a thermally reflective material that operates to reflect and direct radiant heat from the electrical resistance element toward the cover layer while preventing heat ingress into the insulating layer.

3. The hose assembly of claim 2, wherein the thermal barrier layer is spiral wrapped around the thermally insulating layer.

4. The hose assembly of claim 2, wherein the thermal barrier layer includes one or more of an aluminum foil, a metallic coated film, or a metalized Mylar® film.

5. The hose assembly of claim 2, further comprising a second thermal barrier layer positioned radially outward of the electrical resistance element and between the electrical resistance element and the cover layer.

6. The hose assembly of claim 1, wherein the electrical resistance element is radially positioned between the insulating layer and the cover layer.

7. The hose assembly of claim 1, wherein the electrical resistance element is positioned radially externally relative to the cover layer.

8. The hose assembly of claim 1, wherein the electrical resistance element is configured to provide a level of heat to the cover layer sufficient to raise a temperature of a radially external surface of the cover layer by 5° C. to 17° C.

9. The hose assembly of claim 1, wherein the electrical resistance element is configured to provide a level of heat to the cover layer sufficient to raise a temperature of a radially external surface of the cover layer by an amount sufficient to be above an ambient dew point temperature.

10. The hose assembly of claim 1, wherein the electrical resistance element is configured as wound helical wiring spiral-wrapped radially externally relative to the thermally insulating layer.

11-14. (canceled)

15. The hose assembly of claim 1, further comprising a reinforcing layer positioned radially externally relative to the inner hose core.

16. The hose assembly of claim 15, wherein the reinforcing layer is wrapped around the inner hose core radially internally relative to the thermally insulating layer.

17. (canceled)

18. The hose assembly of claim 1, further comprising an electromagnetic interference (EMI) shielding layer positioned externally relative to the electrical resistance element.

19. (canceled)

20. The hose assembly of claim 18, wherein the EMI shielding layer is applied radially externally relative to the electrical resistance element and radially internally relative to the cover layer.

21. (canceled)

22. The hose assembly of claim 1, wherein the thermally insulating layer includes a PTFE-based or silica-based aerogel insulation material that is infused into a base matrix including one or more of fiberglass, felt, or a fiber matrix.

23. The hose assembly of claim 1, wherein the thermally insulating layer includes a strip of insulating material that is spiral wrapped radially externally relative to the inner core tube.

24-25. (canceled)

26. The hose assembly of claim 1, further comprising:
a first shroud that encompasses a first end of the hose assembly; wherein the electrical resistance element includes lead wires that are electrically connected to wiring of the electrical resistance element, the lead wires extending through passages formed through an outer wall of the first shroud for connection to an external input power source; and
a set of first spliced connections that is located internally within the first shroud and that electrically connects the lead wires to the wiring of the electrical resistance element.

27. The hose assembly of claim 26, further comprising:
a second shroud that encompasses a second end of the hose assembly opposite from the first end; and
a second spliced connection that is located internally within the second shroud and that electrically connects opposing elements of the wiring of the electrical resistance element to each other.

28. The hose assembly of claim 26, wherein the first shroud is configured as a first clam shell that attaches the hose assembly to a first hose fitting for communicating fluid to or from the hose assembly.

29. The hose assembly of claim 27, wherein the second shroud is configured as a second clam shell that attaches the hose assembly to a second hose fitting for communicating fluid to or from the hose assembly.
